(19) United States
(12) Patent Application Publication
(10) Pub. No.: US 2003/0108856 A1
(43) Pub. Date: Jun. 12, 2003

(54) Remote operation system for application software projected onto a screen

(75) Inventor: Akira Masuda, Kanagawa (JP)

Correspondence Address: Doyle B. Johnson, CROSBY, HEAFEY, ROACH & MAY, Two Embarcadero Center, Suite 2000, P.O. Box 7936, San Francisco, CA, 94591, US

(73) Assignee: Sony Corporation

(21) Appl. No.: 10/304,975

(22) Filed: Nov. 26, 2002

(30) Foreign Application Priority Data
Nov. 28, 2001 (JP) P2001-362965

(51) Int. Cl. G09B 3/00

(52) U.S. Cl. 434/350

(57) ABSTRACT

A remote operation system includes a computer, a projector means for projecting onto a screen pictures produced by application software installed on the computer, a first terminal and a plurality of second terminals. The first terminal selects one of the second terminals and allows the selected second terminal to operate application software. The selected terminal operates application software based upon such permission and operations of application software by the terminal are projected onto the screen. In the form of school lesson, the teacher allows students to operate application software while they are being seated.

### BACKGROUND OF THE INVENTION

1. Field of the Invention

The present invention relates to a system for remotely operating application software projected onto a screen such as a so-called electronic white-board.

2. Description of the Related Art

At present, when teachers are giving lessons to students, such a system is becoming very popular in which a teacher operates a variety of application software (hereinafter simply referred to as “application”) through a personal computer to enable students to look at pictures that were projected onto a screen by applications. A so-called electronic white-board is becoming a very popular device including a projection screen.

FIG. 1 is a schematic block diagram showing devices that are provided within a classroom during such school lesson according to the related art. As shown in FIG. 1, within a classroom C, a personal computer 101 for use with a teacher is connected to the Internet. An electronic white-board 102 and a projector 103 for projecting images onto the screen of the electronic white-board 102 are located in front of the classroom C.

A serial port of the personal computer 101 is connected to a serial port of the electronic white-board 102, and an RGB output terminal of the personal computer 101 is connected to an RGB input terminal of the projector 103.

Applications for use in school lesson (e.g. Web browsers, word processing software, etc.) and software for effecting serial communication between the personal computer 101 and the electronic white-board 102 to execute processing (e.g. software available in the electronic white-board 102 as an accessory product) are installed on the personal computer 101.

When a teacher activates an application, a picture produced by such application is projected onto the screen of the electronic white-board 102 by the projector 103.

The screen of the electronic white-board 102 is composed of a touch-sensitive type touch panel. When a user touches menu or icon projected on the screen with a finger, a command indicative of the position or the number at and in which the user touches the menu or icon is transmitted to the personal computer 101 from the electronic white-board 102 and thereby the personal computer 101 can execute processing in accordance with the command transmitted thereto.

Therefore, while staying near the electronic white-board 102, the teacher is able to operate applications installed on the personal computer 101 by only touching the picture projected onto the screen of the electronic white-board 102.

In this form of school lesson, when the teacher wishes students to practice in operating this application or when a student who has a question wants to ask a question by operating this application, such student has to leave his own seat (desk D shown in FIG. 1) and has to move to and stay near the electronic white-board 102 located in front of the classroom C. Consequently, if the teacher allows many students to practice in operating this application one by one, then a loss of time required when the students have to move to and stay near the electronic white-board 102 increases unavoidably.

If a student who wishes to ask a question had hesitated to move to and stay near the electronic white-board 102, the practice would be ended before the student asks a question.

### SUMMARY OF THE INVENTION

In view of the aforesaid aspect, it is an object of the present invention to provide a remote operation system for remotely operating application software projected onto a screen in which students become able to operate applications in their own seats in the form of school lesson in which pictures produced by applications are projected onto a screen.

According to an aspect of the present invention, there is provided a remote operation system for remotely operating application software projected onto a screen. This remote operation system is comprised of a computer, a projector for projecting onto a screen pictures produced by application software installed on the computer, a first terminal, a plurality of second terminal and an operation device for selecting one of a plurality of second terminals and allowing the selected terminal to operate the application software, wherein the second terminal includes an operation device for designating position by moving a pointer on a screen and the operation device allows the first terminal to operate the application software so that the selected second terminal becomes able to operate the application software.

In accordance with another aspect of the present invention, there is provided a remote operation method for remotely operating application software projected onto a screen. This remote operation method is comprised of the steps of projecting onto a screen pictures produced by application software installed on a computer, selecting one terminal from a plurality of second terminals by a first terminal, allowing the selected terminal to operate the application software by the first terminal, operating application software by moving a pointer on a screen with the selected second terminal and projecting operation of the second terminal onto a screen.

### BRIEF DESCRIPTION OF THE DRAWINGS

FIG. 1 is a schematic block diagram showing various devices provided within a classroom in the form of school lesson using a so-called electronic white-board according to the related art;

FIG. 2 is a schematic block diagram showing an example of an arrangement of a remote operation system according to the present invention;

FIG. 3 is a schematic diagram showing an outward appearance and arrangement of a master unit shown in FIG. 2;

FIG. 4 is a block diagram showing a circuit arrangement of a main portion of the master unit shown in FIG. 2;

FIG. 5A is a front view showing an outward appearance and arrangement of a slave unit shown in FIG. 2;

FIG. 5B is a side view showing an outward appearance and arrangement of the slave unit shown in FIG. 2;

FIG. 6 is a diagram showing an example of a pointer displayed on a screen by application software.

FIG. 7 is a block diagram showing a circuit arrangement of a main portion of the slave unit shown in FIG. 2;

FIG. 8 is a diagram showing an access system that is to be executed between the master unit and the slave unit shown in FIG. 2;

FIG. 9 is a flowchart to which reference will be made in explaining processing executed by the master unit shown in FIG. 2;

FIG. 10 is a flowchart to which reference will be made in explaining processing executed by the slave unit shown in FIG. 2;

FIG. 11 is a diagram showing an example of the manner in which a teacher gives school lesson to students with application of the system shown in FIG. 2;

FIG. 12 is a diagram showing another example of the manner in which a teacher gives school lesson to students with application of the system shown in FIG. 2; and

FIG. 13 is a schematic diagram showing an example of a picture displayed on the screen with application of application software.

### DESCRIPTION OF THE PREFERRED EMBODIMENTS

Embodiments of the present invention that is applied to school lessons in the school will be described with reference to the drawings.

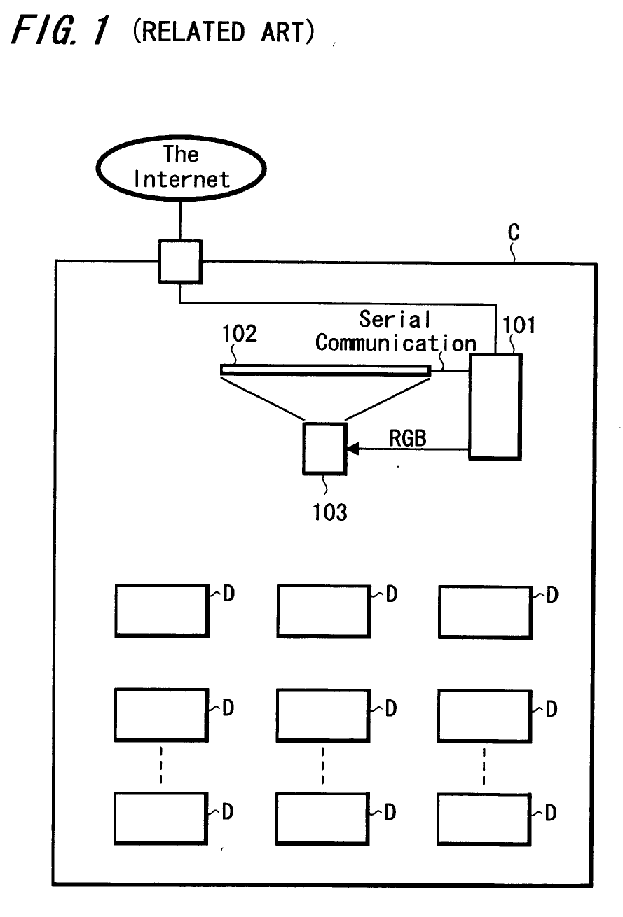

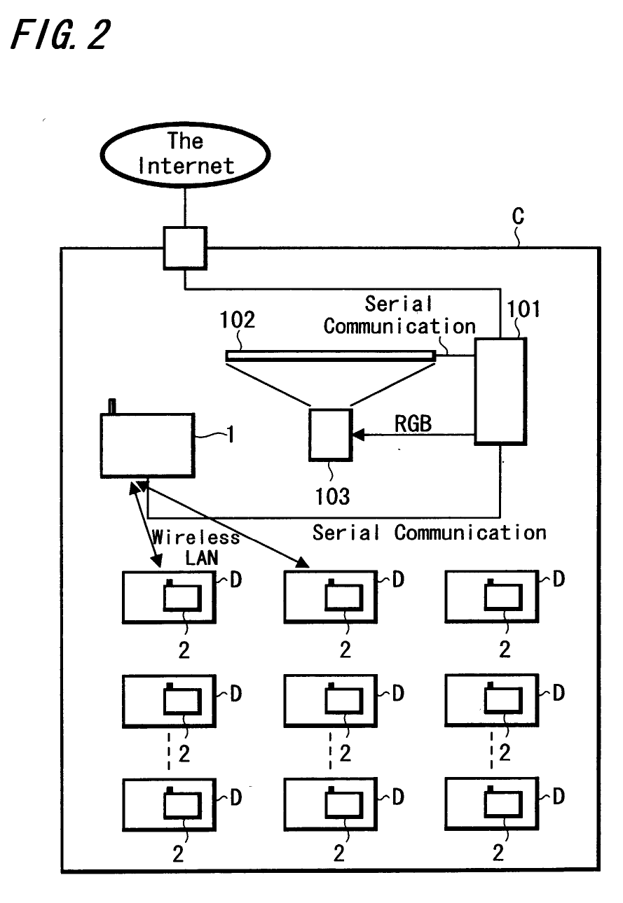

FIG. 2 is a block diagram showing an example of an arrangement of a remote operation system according to the present invention. In FIG. 2, elements and parts identical to those of FIG. 1 are denoted by the identical reference numerals. Also in this remote operation system, as shown in FIG. 2, the personal computer 101 that a teacher uses in the classroom C is connected to the Internet. The electronic white-board 102 and the projector 103 that projects pictures on the screen of the electronic white-board 102 are provided in front of the classroom C.

In this remote operation system, a teacher uses a portable terminal 1 of size that can be hand-held with one hand (this terminal will hereinafter be referred to as a “master unit 1”). A terminal 2 is disposed on the desk D of each student (this terminal will hereinafter be referred to as a “slave unit 2”). In school lessons, students are usually using these slave units 2.

A serial port of the personal computer 101 is connected to the serial port of electronic white-board 102, and an RGB output terminal of the personal computer 101 is connected to the RGB input terminal of the projector 103. Another serial port of the personal computer 101 is connected to a serial port, which will be described later on, of the master unit 1.

Application software (e.g. Web browser, word processing software, etc.) available in the school lessons and software for executing processing by serial communication between the personal computer 101 and the electronic white-board 102 (software available in the electronic white-board 102 as an accessory product) are installed on the personal computer 101. Further, software that is used to execute processing by serial communication between the personal computer 101 and the master unit 1 is also installed on the personal computer 101.

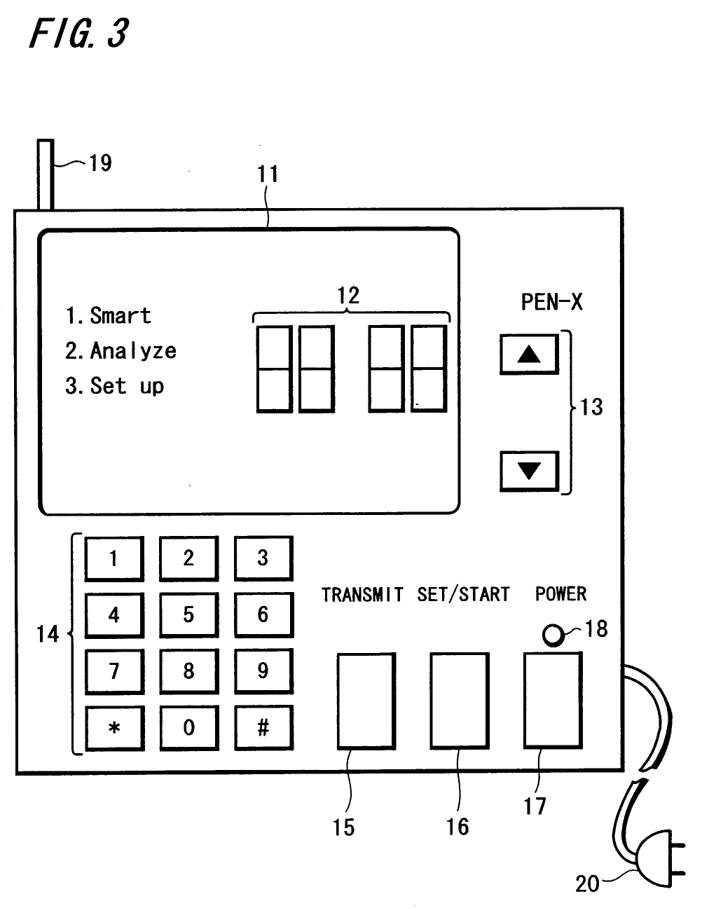

FIG. 3 shows outward appearance and arrangement of the master unit 1. The master unit 1 has a front panel on which there are disposed a dot-matrix type liquid-crystal display screen 11, scroll keys 13, a key group 14 of numeral keys “0” to “9” and symbols “*”, “#”, a TRANSMITTER key 15, a SET/START key 16, a power-supply key 17 and a power lamp (LED (light-emitting diode)) 18. These key groups are the operation means available in the master unit 1.

Characters of “1. Smart”, “2. Analyze” and “3. Set up” which indicate three modes of the master unit 1 are displayed on the left portion of the liquid-crystal display screen 11. The right portion of the liquid-crystal display screen 11 serves as a numeral display area 2 for displaying numerals of left and right two columns and rows in the form of segment electrodes.

A mode “Smart” is a mode in which one slave unit 2 is permitted to remotely operate application software.

A mode “Analyze” is a mode in which answer information, which will be described later on, from each slave unit 2 is totalized.

A mode “Set up” is a mode in which address information (ID number) of IEEE802.11b format, which is the wireless LAN standard, is given to the slave unit 2.

Scroll keys 13 are keys that are used to select one desired mode of these modes “Smart”, “Analyze” and “Set up”.

Key group 14 is used to enter address information which will be given to the slave unit 2 in the mode “Set up”, to enter address information given to the slave unit 2, which will be permitted to remotely operate application software, in the mode “Smart” (i.e. to select the slave unit 2 which will be permitted to remotely operate application software) and to enter a choice number of a correct answer for a question that had been set to students in a multiple-choice test in the mode “Analyze”.

A TRANSMIT key 15 is used to transmit information indicative of address information (address information entered by the key group 14) given to the slave unit 2 to the slave unit 2 in the mode “Set up”, to transmit remote operation permission information to the slave unit 2 (slave unit 2 whose address information had been entered by the key group 14) which will be permitted to remotely operate application software in the mode “Smart” and to transmit information indicative of a choice number (choice number entered by the key group 14) of a correct answer for a question of a multiple-choice test in the mode “Analyze”.

A SET/START key 16 is used to enable each slave unit 2 to transmit answer information.

The numeral display area 12 on the liquid-crystal display screen 11 is the area that is used to display numerals entered by the key group 14 or to display a totalized result (e.g. the number of correct solvers) of answers at the respective slave units 2.

As shown in FIG. 3, the master unit 1 has a wireless LAN antenna 19 provided on its sidewall and has also a power-supply cable 20 for an AC plug socket attached to its side wall. Although not shown, the master unit 1 has a serial port and a dry cell compartment serving as a power-supply provided on its side wall.

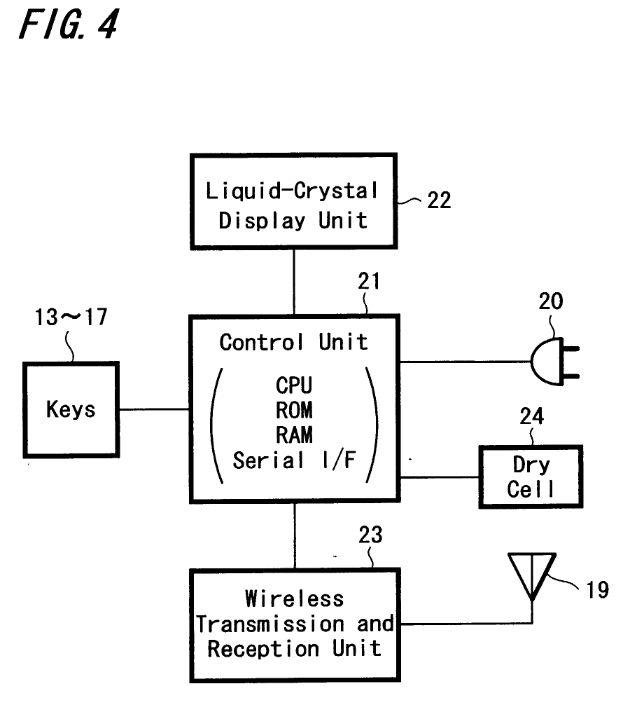

FIG. 4 shows a circuit arrangement of the main portion of the master unit 1. As shown in FIG. 4, a liquid-crystal display portion 22 including the liquid-crystal display screen 11 shown in FIG. 1, the respective keys 13 to 17 shown in FIG. 2, the wireless transmission and reception unit 23, the power-supply cable 20 shown in FIG. 1 and a dry cell 24 stored in the dry cell compartment are connected to a control unit 21 which includes a CPU (central processing unit), a ROM (read-only memory), a RAM (random access memory) and a serial interface (I/F).

The wireless transmission and reception unit 23 is adapted to convert/modulate data supplied from the control unit 21 into a signal conforming to the IEEE802.11b which is the wireless LAN standard and transmits the signal of the IEEE802. 11b to the antenna 19 shown in FIG. 2. Also, the wireless transmission and reception unit 23 demodulates/inverse-converts the IEEE802.11b signal received at the antenna 19 and transmits a resultant signal to the control unit 21.

The serial port of the serial interface (serial I/F) within the control unit 21 is connected to the serial port of the personal computer 101 as mentioned before.

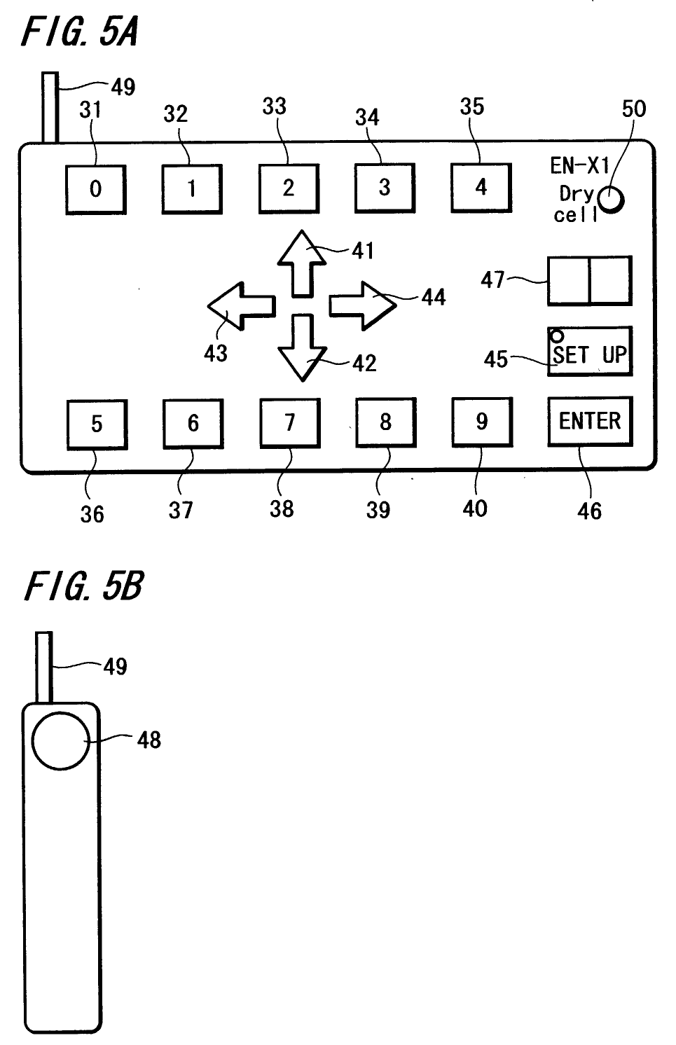

FIGS. 5A and 5B are respectively a front view and a side view showing the outward appearance and arrangement of the slave unit 2. As illustrated, the slave unit 2 has a front panel on which there are provided keys 31 to 41 with numerals “0” to “9” printed thereon, arrow-like direction keys 41, 42, 43, 44 that are directed in the upper direction, the lower direction, the left direction and the right direction, a SETUP key 45, an ENTER key 46 and a display portion 47 that displays two-digit numerals in the form of segment electrodes. These key groups are the operation means available in the slave unit 2.

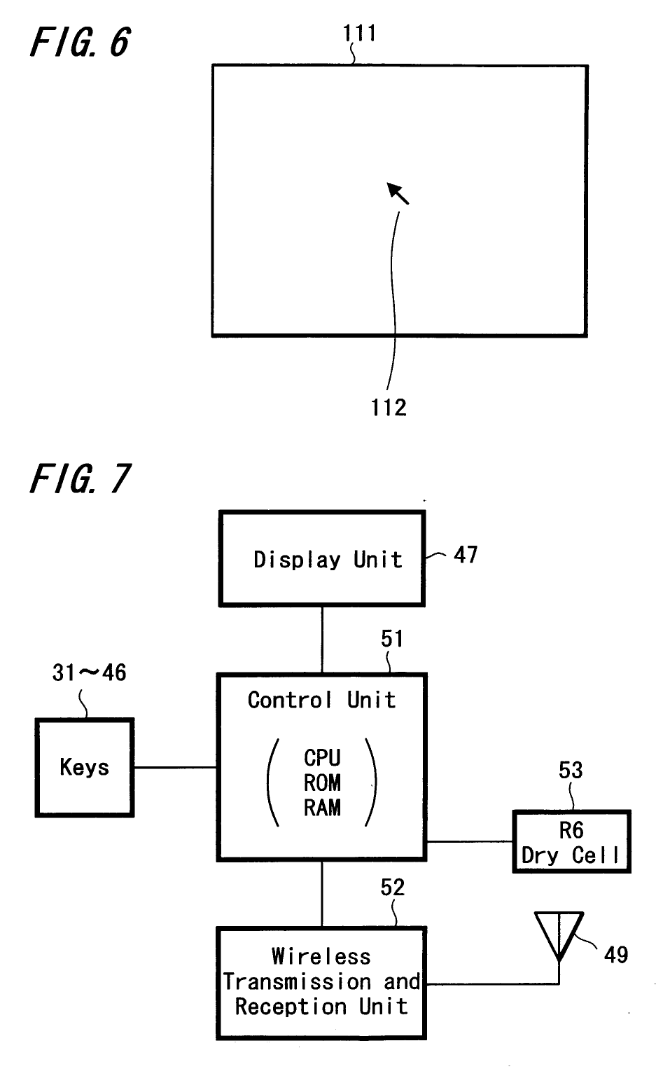

The direction keys 41, 42, 43 and 44 are those that are used to move a pointer 112 in the upper direction, the lower direction, the left direction and the right direction after the pointer 112 had been displayed on the screen 111 by application software installed on the personal computer 101 as shown in FIG. 6.

The keys 30 to 40 are used to select a choice number of a correct answer for a question that had been set to students in the multiple-choice test by the teacher. Further, the keys 32, 33 and 34 serve as also keys that can set speed at which the pointer 112 is moved by the direction keys 41 to 44 to high-speed, middle-speed and low-speed.

The SETUP key 45 is a key that can determine results selected or set by the keys 31 to 40.

The ENTER key 46 is a key that can enter the position at which the pointer 112 is located by the direction keys 41 to 44.

The slave unit 2 can be driven by an R6 dry cell. As shown in FIG. 5B, the slave unit 2 has a dry cell compartment 48 for housing therein this R6 dry cell and a wireless LAN antenna 49 disposed on its side wall. An LED (light-emitting diode) lamp 50 is provided on the front panel of the slave unit 2 in order to warn users before the dry cell is consumed completely.

The slave unit 2 is of size suitable for being placed on the desk D (FIG. 2) of student when in use (the slave unit 2 also may be of size that can be hand-held similarly to the master unit 1).

FIG. 7 shows a circuit arrangement of the slave unit 2. As shown in FIG. 7, the keys 31 to 46 shown in FIG. 5, the display unit 47 shown in FIG. 5, the wireless transmission and reception unit 52 and the R6 dry cell 53 housed within the dry cell compartment 48 shown in FIG. 5 are connected to the control unit 51 that includes the CPU, the ROM and the RAM.

The wireless transmission and reception unit 52 converts/modulates data transmitted from the control unit 51 into the signal of the IEEE802.11b, which is the wireless LAN standard, and transmits the converted/modulated IEEE802.11b signal to the antenna 49 shown in FIG. 5. Also, the wireless transmission and reception unit 52 is adapted to demodulate/inverse-convert the IEEE802. 11b signal received at the antenna 49 and transmits the demodulated/inverse-converted signal to the control unit 51.

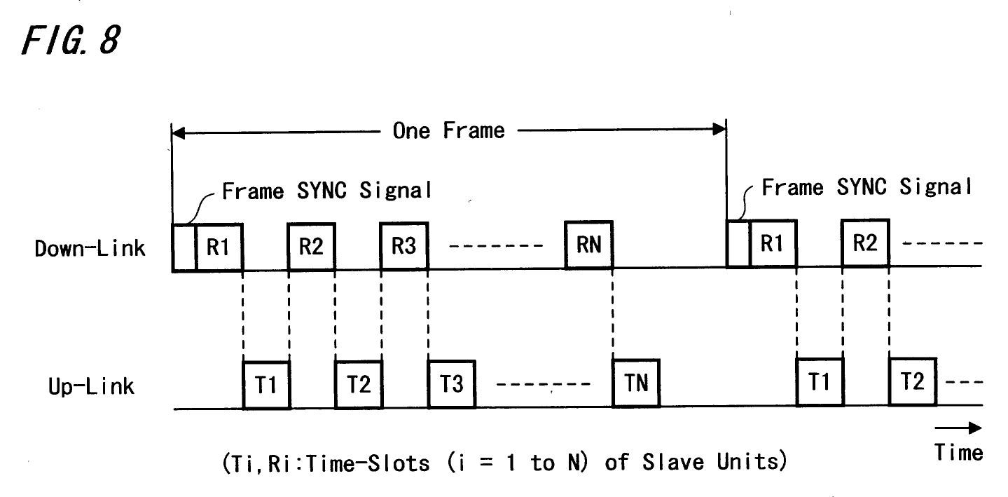

Communication is effected between the master unit 1 and the slave unit 2 by wireless LAN under access system shown in FIG. 8. As shown in FIG. 8, time-slots (up-link time-slot T1, down-link time-slot R1, time-slots T2 and R2, time-slots T3 and R3, . . . time-slots TN and RN) are allocated to the respective slave units 2 (100 slave units 2(1), 2(2), . . . 2(N)) to which address information are given by the master unit 1, respectively.

The master unit 1 transmits data, commands and the like to each slave unit 2 to which address information is given during the down-link time-slots allocated to the slave unit 2. The respective slave units 2 with address information given thereto transmit data and the like to the master unit 1 during the up-link time-slots allocated to the slave unit 2.

One time-slot has a duration of 10 milliseconds and one frame has a duration of one second. The communication speed is 5 Mbps both in the up-link and the down-link. Communication between the master unit 1 and each slave unit 2 is permitted to have a delay time of one second at maximum, for example.

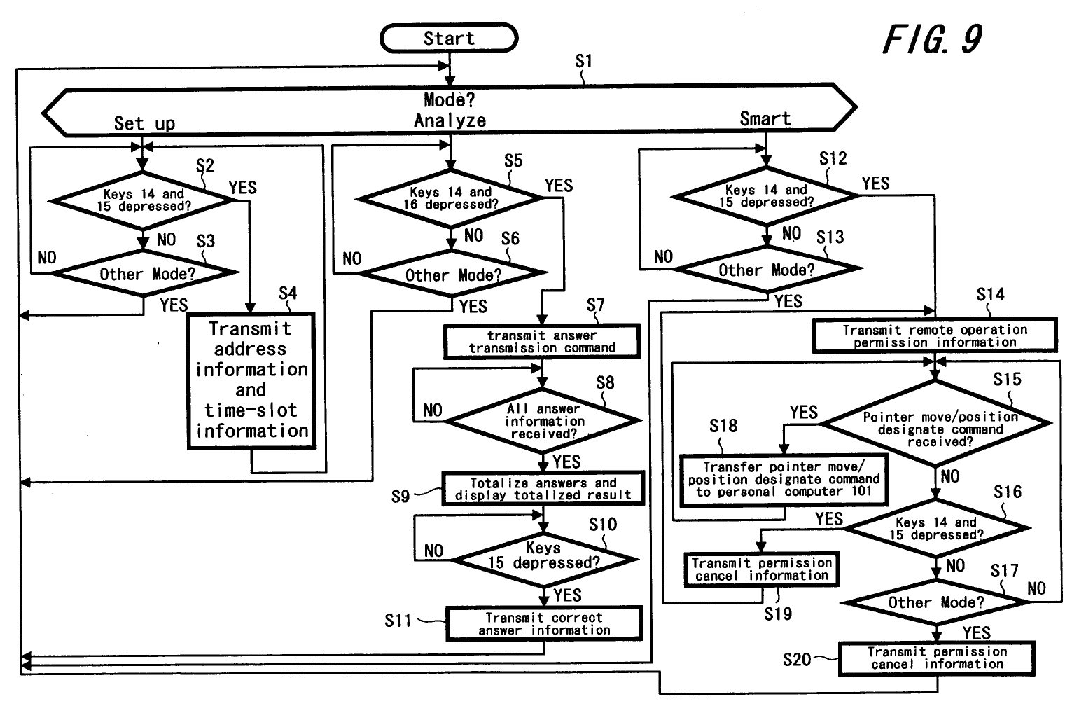

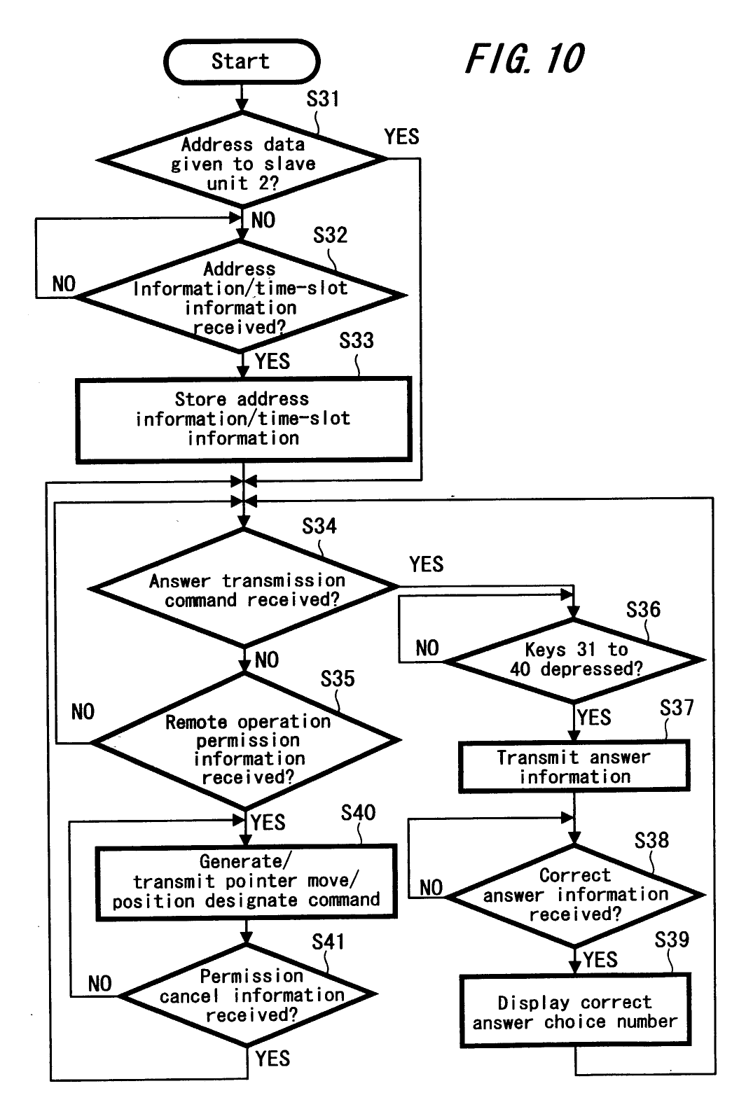

FIG. 9 is a flowchart to which reference will be made in explaining processing executed by the CPU (FIG. 4) within the control unit 21 of the master unit 1. FIG. 10 is a flowchart to which reference will be made in explaining processing executed by the CPU (FIG. 7) within the control unit 51 of the slave unit 2.

Referring to FIG. 9, and following the start of operation, control goes to a decision step S1, whereat the CPU in the master unit 1 determines which mode in the three modes “Smart”, “Analyze” and “Set up” is selected by the scroll key 13.

If the mode “Set up” is selected by the scroll key 13 at the decision step S1, then control goes to the next decision step S2, whereat it is repeatedly determined whether or not the TRANSMIT key 15 is depressed after data (address information) had been entered by the key group 14. Further, repeatedly, it is determined at the next decision step S3 whether the different mode, i.e. the mode “Smart” or the mode “Analyze” is selected by the scroll key 13.

If a YES is outputted at the decision step S3, then control goes back to the decision step S1. If on the other hand a YES is outputted at the decision step S2, then control goes to a step S4, whereat information indicative of address data entered by the key group 14 and information indicative of time-slots allocated to the base unit 2 with the above address information given thereto are transmitted (during time periods other than the time-slots T1, R1 to TN and RN that had already been allocated during the frame shown in FIG. 8).

Referring to FIG. 10, and following the start of operation, it is determined by the CPU of the slave unit 2 at the next decision step S31 whether or not address information had already been given to the slave unit 2. If address data is not given to the slave unit 2 as represented by a NO at the decision step S31, then control goes to the next decision step S32, whereat it is repeatedly determined by the CPU of the slave unit 2 whether or not the slave unit 2 has received this address information and time-slot information from the master unit 1. If a YES is outputted at the decision step S32, then control goes to a step S33, wherein this address information and time-slot information are stored.

Referring back to FIG. 9, if it is determined by the CPU of the master unit 1 at the decision step S1 that the mode “Analyze” is selected, then it is repeatedly determined by the CPU of the master unit 1 at the decision step S5 whether or not the SET/START key 16 is depressed after information (information indicative of choice number of correct answer) had been entered by the key group 14 and also it is repeatedly determined by the CPU of the master unit 1 at the decision step S6 whether the different mode, i.e. mode “Smart” or “Set up” is selected.

If a YES is outputted at the step S6, then control goes back to the step S1. If on the other hand a YES is outputted at the step S5, then control goes to a step S7, whereat a command indicative of transmission of answer is transmitted to each slave unit 2 to which the address information is given.

As shown in FIG. 10, after the step S33 had been ended or if the address information had already been given to the slave unit 2, then control goes to the next decision step S34 it is repeatedly determined by the CPU of the slave unit 2 whether or not this answer transmission command is received by the slave unit 2 and control goes to the next decision step S35, whereat it is repeatedly determined by the CPU of the slave unit 2 whether or not information that permit remote operation of application software is received by the slave unit 2.

If a YES is outputted at the decision step S34, then control goes to the next decision step S36, whereat it is determined by the CPU of the slave unit 2 the SETUP key 45 is depressed after any one of the keys 31 to 40 had been depressed.

If a YES is outputted at the decision step S36, then control goes to a step S37, whereat information indicative of the number (selected answer (choice number)) corresponding to the depressed key of the keys 31 to 40 is transmitted to the master unit 1.

Referring back to FIG. 9, after the step S7, it is repeatedly determined at the step S8 by the CPU of the master unit 1 whether or not the master unit 1 received answer information from all slave units 2 to which address information are given.

If a YES is outputted at the decisions step S8, control goes to a step S9, whereat answers at the respective slave units 2 are totalized (e.g. the number of correct solvers is calculated) based upon results of data inputted by the key group 14 (choice number of correct answer) and the totalized result is displayed on the numeral display area 12 of the liquid-crystal display screen 11.

Subsequently, it is repeatedly determined by the CPU of the master unit 1 at the step S10 whether or not the TRANSMIT key 15 is depressed.

If a YES is outputted at the decision step S10, then control goes to a step S11, whereat information indicative of the choice number of the correct answer entered by the key group 14 is transmitted to each slave unit 2. Then, control goes back to the step S1.

Referring to FIG. 10, after the step S37, control goes to the next decision step S38, whereat it is repeatedly determined by the CPU of the slave unit 2 whether or not the slave unit 2 received the correct answer information from the master unit 1.

If a YES is outputted at the decision step S38, then control goes to a step S39, whereat the choice number of the correct answer is displayed on the display unit 47 based upon this correct answer information. Then, control goes back to the step S34.

As shown in FIG. 9, if the mode “Smart” is selected at the step S1, then control goes to a decision step S12, whereat it is repeatedly determined by the CPU of the master unit 1 whether or not the TRANSMIT key 15 was depressed after information had been entered by the key group 14 (after address information had been inputted). Also, control goes to a decision step S13, whereat it is repeatedly determined by the CPU of the master unit 1 whether the different mode, i.e. the mode “Set up” or the mode “Analyze” is selected.

If a YES is outputted at the step S13, then control goes back to the step S1. If on the other hand a YES is outputted at the step S12, then control goes to a step S14, whereat information that permits remote operation of application software is transmitted to the slave unit 2 to which the address information is given by the key group 14.

Referring to FIG. 10, if a YES is outputted at the step S35 after this remote operation permission information had been received at the slave unit 2, then control goes to a step S40, whereat the CPU of the slave unit 2 generates commands that move the pointer 112 on the screen 111 in response to operation contents of the keys 32 to 34, the SETUP key 45, the direction keys 41 to 44 and the ENTER key 46 and which designate the position on the screen 111 (commands for moving the pointer 112 on the screen 111 at speed selected and determined by the ENTER key 46 in the direction of the corresponding key during a time period corresponding to a time period in which each of the direction keys 41 to 44 is depressed and commands for designating the position at which the pointer 112 is placed at the time when the ENTER key 46 is depressed) and transmits these commands to the master unit 1.

As shown in FIG. 9, after the step S14, control goes to the next decision step S15, whereat it is repeatedly determined by the CPU of the master unit 1 whether or not the pointer move/position designate command is received by the master unit 1. Also, control goes to a decision step S16, whereat it is repeatedly determined by the CPU of the master unit 1 whether or not the TRANSMIT key 15 was depressed after new information had been entered by the key group 14 (address information had been inputted). Further, control goes to a step S17, whereat it is repeatedly determined by the CPU of the master unit 1 whether the different mode, i.e. the mode “Set up” or the mode “Analyze” is selected.

If a YES is outputted at the step S15, then control goes to a step S18, whereat this pointer move/position designate command received from the slave unit 2 is transferred from the serial interface within the control unit 21 (FIG. 4) to the personal computer 101. After the step S18, control goes back to the step S15.

If a YES is outputted at the decision step S16, then control goes to a step S19, whereat information that cancels the permission of the remote operation of the application software is transmitted to the slave unit 2 to which the remote operation permission information had been transmitted at the step S14 just before. Then, control goes back to the step S14, whereat the remote operation permission information is transmitted to slave unit 2 to which newly inputted address information is given.

If a YES is outputted at the step S17, control goes to a step S20, whereat the permission cancel information is transmitted to the slave unit 2 to which the remote operation permission information had been transmitted at the step S14 just before similarly to the step S19. Then, control goes back to the step S1.

As shown in FIG. 10, while it is periodically being determined at the step S41 by the CPU of the slave unit 2 whether or not the slave unit 2 received this permission cancel information from the master unit 1, the CPU of the slave unit 2 repeats this step S40 until the slave unit 2 receives the permission cancel information. If the slave unit 2 received this permission cancel information from the master unit 1 as represented by a YES at the decision step S41, then control goes back to the step S34.

Next, how to go on with this school lesson using this system will be described. At the beginning, before starting the school lesson by using this system, a teacher has to select in advance the mode “Set up” by the scroll key 13 of the master unit 1 and has to depress the TRANSMIT key 15 after the teacher had inputted address information given to the slave units 2 at every slave unit 2 (e.g. address information of the same numbers as the roll numbers of students who use the slave units 2). In consequence, the steps S1, S2, S4 shown in FIG. 9 are executed and the steps S31 to S33 shown in FIG. 10 are executed, whereby address information is given to each slave unit 2.

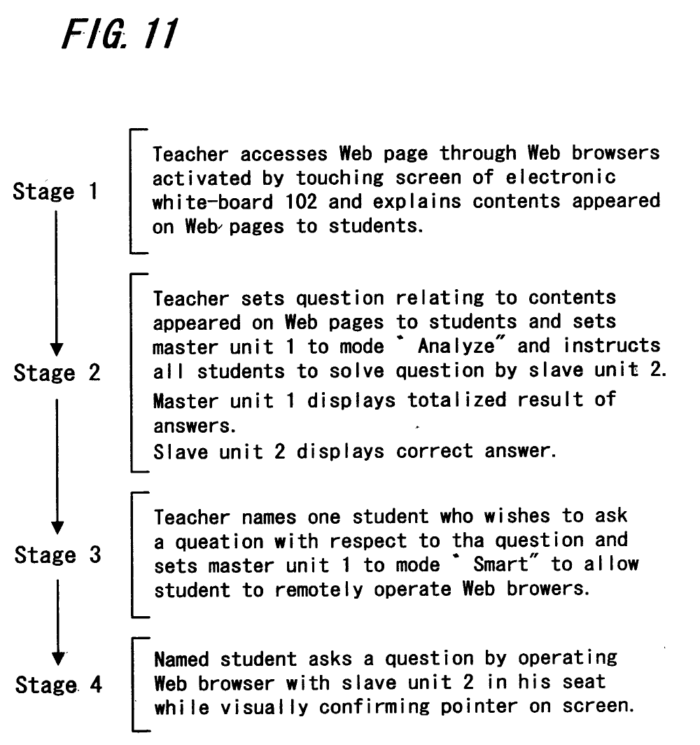

FIG. 11 is a diagram showing an example of how to go on with the school lesson using this system. First, as shown on the stage 1, the teacher activates a Web browser on the personal computer 101. Then, the teacher accesses various Web pages by operating Web browsers on the projected pictures (pictures of the Web browsers) on the screen of the electronic white-board 102 and explains contents of these Web pages to the students.

Subsequently, as shown on the stage 2, the teacher sets a multi-choice form question to the students in association with the contents of those Web pages. At the same time, the teacher selects the mode “Analyze” by the scroll key 13 of the master unit 1, enters the choice number of the correct answer of this question and depresses the SET/START key 16. Then, all students are allowed to select the correct answer (choice number) of this question with the keys 31 to 40 of the slave unit 2.

Thus, the steps S5, S7 to S9 shown in FIG. 9 and the steps S34, S36, S37 shown in FIG. 10 are executed, whereby a totalized result of answers of respective students (e.g. the number of solvers) is displayed on the numeral display area 12 of the liquid-crystal display screen 11 of the master unit 1.

Having confirmed this totalized result with the numeral display area 12, the teacher depresses the TRANSMIT key 15. Thus, the steps S10, S11 shown in FIG. 9 and the steps S38, S39 shown in FIG. 10 are executed and thereby the choice number of the correct answer of this question is displayed on the display unit 47 of each slave unit 2.

Subsequently, as shown at the stage 3 of FIG. 11, the teacher receives questions concerning this question and calls on one student from those who wish to ask a question. Further, the teacher selects the mode “Smart” by the scroll key 13 of the master unit 1. Then, the teacher inputs address information (e.g. roll number of student as mentioned before) of the slave unit 2 used by the named student by the key group 14 and depresses the TRANSMIT key 15.

As a result, the steps S12, S14 shown in FIG. 9 are executed and the slave unit 2 that the named student is using is allowed to remotely operate the Web browsers.

Subsequently, as shown at the stage 4 of FIG. 11, the named student asks a question. In that case, if the named student wishes to ask a question while operating the Web browser, then the student depresses the direction keys 41 to 44 and the ENTER key 46 of the slave unit 2 while visually confirming the pointer on the projected picture on the screen of the electronic white-board 102 in its seat.

Consequently, the steps S35, S40 shown in FIG. 10 and the steps S15, S18 shown in FIG. 9 are executed. At the same time, the personal computer 101 executes the command transferred from the master unit 1 to the personal computer 101, whereby the pointer is moved on the projected picture of the screen of the electronic white-board 102 and the position is designated. Then, a Web browser is operated in response to the designated position.

To be more concrete, when the teacher is accessing Web pages one by one surfing links on the Web pages at the stage 1 and the student wishes to ask a question by forwarding the Web page to the next page or by returning the Web page to the previous page, the student moves the pointer up to the position of the menu or the icon in order to return to the previous Web page or to proceed to the next Web page on the projected picture on the screen of the electronic white-board 102. Then, the student designates the positions of the menu and the icon by depressing the ENTER key 46.

There are available various methods for returning to the previous page or proceeding to the next page. In the “Netscape Navigator”, for example, there is known a method in which a user selects menus “COMMUNICATOR”, “TOOL” and “HISTORY” in that order and selects URL of desired Web page from URLs displayed as the history. Therefore, the student may move the pointer to the position of “COMMUNICATOR” by the direction keys 41 to 44 and may designate this position by the ENTER key 46. Then, the student may move the pointer to the position of “TOOL” by the direction keys 41 to 44 and may designate this position by the ENTER key 46. Next, the student may move the pointer to the position of “HISTORY” by the direction keys 41 to 44 and may designate this position by the ENTER key 46. Finally, the student may move the pointer to the position of the desired URL in the “HISTOTRY” by the direction keys 41 to 44 and may designate this position by the ENTER KEY 46.

Alternatively, when “TO PREVIOUS PAGE” icon or “TO NEXT PAGE” icon is displayed on the Web page itself, the student may move the pointer to the position of such icon by the direction keys 41 to 44 and may designate this position by the ENTER key 46.

Further, when the Web browser is remotely operated in this way, if speed at which the pointer is moved is too fast or too slow, then the student can increase or decrease the moving speed of the pointer by the keys 32 to 34 of the slave unit 2.

If other student wishes to ask a question after the corresponding student had finished the question, then the teacher can name another student and may enter address information of the slave unit 2 that is used by the newly designated student by the key group 14 of the master unit 1. Then, the teacher may depress the TRANSMIT key 15.

As a result, the steps S16, S19, S14 shown in FIG. 9 are executed and the slave unit 2 that had been permitted to remotely operate this application software so far is inhibited from remotely operating the application software. This time, the slave unit 2 that is used by the newly named student is allowed to remotely operate the application software.

The student thus newly designated also is able to ask a question while operating this application software from the seat by using the slave unit 2.

When no student asks a question anymore and the teacher wishes to make a school lesson while operating the application software one more time, the teacher may select the mode “Analyze” by the scroll key 13 of the master unit 1. Thus, the steps S17, S20 shown in FIG. 9 are executed and the slave unit 2 becomes unable to remotely operate the application software.

As described above, according to this system, in the form of school lesson in which pictures produced by application software are projected onto the screen of the electronic white-board 102, the teacher can set questions to the students in association with the displayed contents of the pictures produced by the application software and operations of the application software and the students can answer by the slave units 2. Then, having visually confirmed the situation under which the students had answered, the teacher can allow the student, who has a question, to ask a question by operating the application software with the slave unit 2.

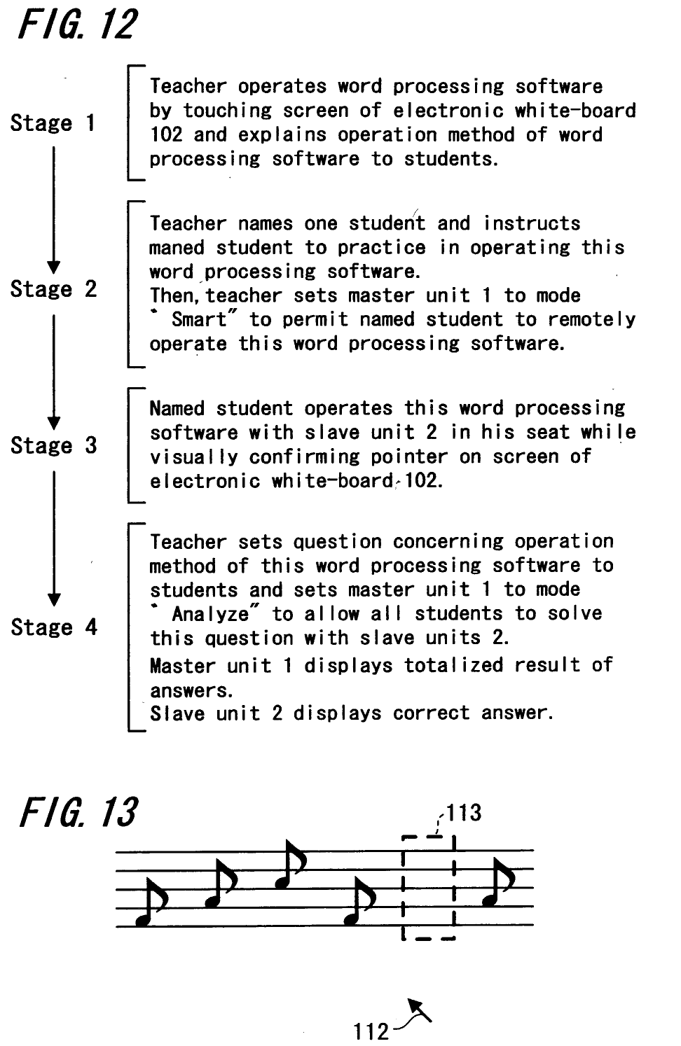

FIG. 12 is a diagram showing another example of how to go on with the school lesson using this system. First, as shown at the stage 1 in FIG. 12, the teacher may activate word processing software, spreadsheet software or music software (application software for composing music by arranging notes on music paper or generating sounds by clicking notes on the score of music) on the personal computer 101. Then, the teacher may explain how to operate application software to the students by actually operating the application software while touching the projected pictures on the screen of the electronic white-board 102.

Subsequently, as shown on the stage 2, the teacher may call on one student and instruct the named student to practice in operating this application software. Further, after the teacher had selected the mode “Smart” by the scroll key 13 of the master unit 1, the teacher may enter address data of the slave unit 2 that the named student uses by the key group 14 and operate the TRANSMIT key 15.

Consequently, the steps S12, S14 shown in FIG. 9 are executed and the slave unit 2 that the named student uses is allowed to remotely operate this application software.

Subsequently, as shown on the stage 3 in FIG. 12, while being seated, the named student may depress the direction keys 41 to 44 and the ENTER key 46 of the slave unit 2 by visually confirming the pointer on the projected pictures of the screen of the electronic white-board 102.

As a result, the steps S35, S40 shown in FIG. 10 and the steps S15, S18 shown in FIG. 9 are executed. At the same time, the personal computer 101 executes the command transferred from the master unit 1 to the personal computer 101, whereby the pointer is moved on the projected picture of the screen of the electronic white-board 102 and the position is designated. This application software is operated in response to the designated position.

To be more concrete, this application software is word processing software “Word” (registered trademark) or spreadsheet software “Excel” (registered trademark). When the teacher changes sizes and colors of fonts by sequentially selecting “form” and “font” on the menu bar at the stage 1 and instructs the student to exercise the same operations at the stage 2, while remembering what menus the teacher had selected and how the teacher had selected the menus, the student repeats the process in which the student moves the pointer to the position of the menu by the direction keys 41 to 44 and designates this position by the ENTER key 46.

Alternatively, when this application software is music application software, the teacher arranges notes on the music paper at the stage 1 as shown in FIG. 13 (this is not limited to the following case and may be changed depending upon a musical note selection method in the music application software. For example, when the teacher repeats a work in which the pointer 112 is moved to the desired position on the music paper and the position of the pointer 112 is designated, the note at the position on the music paper is determined by designating the position while the pointer 112 is moved to the position of the icon of the desired note in the column in which icons of all musical notes are displayed) and the teacher removes one musical note from one portion 113 and instructs the students to complete music by filling a proper musical note into the blank portion 113, first, the students move the pointer 112 to the position of that note by the direction keys 41 to 44 with respect to individual musical notes on the music paper of this music and generate sound by designating the position with the ENTER key 46. Thus, the students are able to confirm the rhythm of the corresponding music.

Then, having judged a proper music note that should be filled into the blank portion 113, the student arranges a musical note at the blank portion 113 by the direction keys 41 to 44 and the ENTER key 46 (for example, after having moved the pointer 112 to the blank portion 113 by the direction keys 41 to 44 and designated the position of the pointer 112 by the ENTER key 46, the student moves the pointer 112 to the position of the icon of the note suitable for the blank portion 113 in the columns in which all kinds of notes are displayed and designates the position of the pointer 112 by the ENTER key 46, thereby the note of the blank portion being determined).

When the word processing software, the spreadsheet software or the music software is remotely operated, if the movement speed of the pointer is too fast or too slow in association with a distance between the students and the electronic white-board 102, the size of the electronic white-board 102 and displayed contents of the pictures, then the student is able to increase or decrease the moving speed of the pointer by the keys 32 to 34 of the slave unit 2.

Subsequently, as shown at the stage 4 in FIG. 12, the teacher sets a multiple-choice question relating to the application software operation method that the students had exercised at the stage 3 to the students (e.g. question of how to select a correct operation method). Then, the teacher selects the mode “Analyze” by the scroll key 13 of the master unit 1, enters the choice number of the correct answer for this question by the key group 14 and depresses the SET/START key 16. Then, the teacher orders all students to select an answer (choice number) of this question with the keys 31 to 40 of the slave unit 2.

Consequently, the steps S5, S7 to S9 shown in FIG. 9 and the steps S34, S36, S37 shown in FIG. 10 are executed and a totalized result (e.g. number of solvers) of answers of students is displayed on the numeral display area 12 of the liquid-crystal display screen 11 of the master unit 1.

Having visually confirmed the totalized result on the numeral display area 12, the teacher depresses the TRANSMIT key 16. Thus, the steps S10, S11 shown in FIG. 9 and the steps S38, S39 shown in FIG. 10 are executed and the choice number of the correct answer of this question is displayed on the display unit 47 of each slave unit 2.

As described above, according to this system, in the form of the school lesson in which pictures produced by application software are projected onto the screen of the electronic white-board 102, after the students have operated the application software with the slave units 2, the teacher sets the problem concerning the operation of the application software to the students, the students answer the problem with the slave units 2 and the teacher becomes able to visually confirm the situation in which the students had answered by the base unit 1.

As described above, according to this system, since the application software whose pictures are projected onto the screen of the electronic white-board 102 can be remotely operated by one slave unit (slave unit selected by using the master unit 1) of a plurality of slave units 2, the students can remotely operate this application software one by one while they are being seated on their own seats. Therefore, a loss of time produced when students are moved in order to carry out this operation can be removed and hence the teacher can advance and enhance school lessons smoothly.

Since speed at which the pointer is moved on the picture can be set freely in response to a distance between the students and the electronic white-board 102, the size of the screen of the electronic white-board 102, the contents of displayed pictures on the screen, etc., operability at which users remotely operate applications can be improved more.

Since the slave unit 2 and the master unit 1 are not limited to the terminal for remotely operating applications and the terminal for permitting this remote operation and may be used as a terminal for answering by selecting choices with respect to a question associated with applications and can be used as a terminal for confirming the situations of answers, school lesson can be enhanced more effectively by a combination of operation of applications by students, contents of displayed pictures and questions associated with operations of applications.

In the above-mentioned embodiments, the commands by which the slave unit 2 moves the pointer on the picture and designates the position on the picture in response to the contents in which the keys 32 to 34, the SETUP key 45, the direction keys 41 to 44 and the ENTER key 46 are operated are transmitted to the master unit 1 and the master unit 1 transfers the commands to the personal computer 101 through serial communication (step S40 in FIG. 10 and step S18 in FIG. 9).

The present invention is not limited to the above-mentioned embodiments and such a variant is also possible in which the personal computer 101 also may be connected to the wireless LAN through a wireless LAN card attached to the personal computer 101 and the slave unit 2 may directly transmit the command to the personal computer 101.

While pictures produced by applications are projected onto the screen of the electronic white-board as described above, the present invention is not limited thereto and pictures produced by applications may be projected onto an ordinary screen. Also in that case, students are able to operate applications one by one in their seats in exactly the same manner as described above.

While the present invention is applied to the school lessons in the school as described above, the present invention is not limited thereto and can be similarly applied to various presentations and lecture meetings in which presentation and lecture are made by projecting pictures produced from applications onto a screen (presenter or lecturer may use the master unit 1 and audience may use the slave units 2).

While the master unit 1 and the slave unit 2 are respectively used as exclusively-designed terminals as described above, the present invention is not limited thereto. By way of example, application software that can execute functions equivalent to those of the master unit 1 and the slave unit 2 may be installed on personal computers. Specifically, personal computers connected through networks may be disposed on the student disks D and those personal computers may execute functions of the slave units 2. Further, the functions of the master unit 1 may be realized by installing application software on the personal computer 101 for use with the teacher. In that case, the functions of the master unit 1 can be realized by properly assigning operation button groups of the master unit 1 and the slave unit 2 to keys on a keyboard, a mouse, a track-ball of a personal computer and other operation means.

Having described preferred embodiments of the invention with reference to the accompanying drawings, it is to be understood that the invention is not limited to those precise embodiments and that various changes and modifications could be affected therein by one skilled in the art without departing from the spirit or scope of the invention as defined in the appended claims.

What is claimed is:

1. A remote operation system for remotely operating application software projected onto a screen comprising:
computer;
projector means for projecting onto a screen pictures produced by application software installed on said computer;
a first terminal; and
a plurality of second terminals;
wherein said first terminal includes operation means for selecting one of said plurality of second terminals and allowing said selected terminal to operate said application software, said second terminal includes operation means for designating position by moving a pointer on a screen and becomes able to operate said application software in accordance with said first terminal's allowing said second terminal to operate said application software.

2. A remote operation system for remotely operating application software projected onto a screen according to claim 1, wherein said second terminal includes transmission means and transmits a command to said first terminal and said second terminal includes reception means for receiving said command and transfer means for transferring said command received by said reception means to said computer.

3. A remote operation system for remotely operating application software projected onto a screen according to claim 1, wherein said transmission means transmits said command to said computer.

4. A remote operation system for remotely operating application software projected onto a screen according to claim 1, wherein said second terminal further includes setting means for varying speed at which said pointer moves.

5. A remote operation system for remotely operating application software projected onto a screen according to claim 1, wherein said second terminal further includes selection means for selecting any one of a plurality of choices and transmission means for transmitting information indicative of choice selected by said selection means to said first terminal and said first terminal further includes reception means for receiving information indicative of said choices transmitted from said second terminal and display means for displaying data based upon information indicative of said choice received at said reception means.

6. A remote operation system for remotely operating application software projected onto a screen according to claim 1, wherein said second terminal communicates with said computer or said first terminal by wireless.

7. A remote operation method for remotely operating application software projected on to a screen comprising the steps of:
projecting onto a screen pictures produced by application software installed on a computer;
selecting one terminal from a plurality of second terminals by a first terminal;
allowing said selected terminal to operate said application software by said first terminal;
operating application software by moving a pointer on a screen with said selected second terminal; and
projecting operation of said second terminal onto a screen.
